(19) United States
(12) Patent Application Publication
(10) Pub. No.: US 2017/0154239 A1
(43) Pub. Date: Jun. 1, 2017

(54) METHOD FOR FEATURE DESCRIPTION AND FEATURE DESCRIPTOR USING THE SAME

(71) Applicant: INDUSTRIAL TECHNOLOGY RESEARCH INSTITUTE, Hsinchu (TW)

(72) Inventors: Wei-Shuo LI, Kaohsiung City (TW); Jung-Yang KAO, Wandan Township (TW)

(73) Assignee: INDUSTRIAL TECHNOLOGY RESEARCH INSTITUTE, Hsinchu (TW)

(21) Appl. No.: 14/978,699

(22) Filed: Dec. 22, 2015

(30) Foreign Application Priority Data
Dec. 1, 2015 (TW) 104140191

(51) Int. Cl. G06K 9/46

(52) U.S. Cl. CPC G06K 9/4671

(57) ABSTRACT

A method for feature description is provided. The method includes steps of: receiving high dimension data corresponding to a feature patch obtained by a feature extraction algorithm; selecting a plurality of dimension data sets from the high dimension data; comparing different dimension data in each dimension data set to generate a corresponding comparing result for each dimension data set; and generating a binary string according to the comparing results to descript the feature patch.

This application claims the benefit of Taiwan application Serial No. 104140191, filed Dec. 1, 2015, the disclosure of which is incorporated by reference herein in its entirety.

### TECHNICAL FIELD

The disclosure relates in general to a method for feature description, in which feature patch is descripted by using binary string, and a feature descriptor using the same.

### BACKGROUND

Feature descriptor has been widely used in various application fields of image processing such as image recognition, 3D modelling, and tracing. The feature descriptor descripts the features of detected images for subsequent comparison and application. In general, image recognition needs to extract the features of each image and further compares the extracted features with a reference feature of the database to locate the best matching target. However, when a large quantity of features is extracted from the images, the required comparison time will be greatly increased. Besides, if the features carry a large volume of data, more memory space will be required for storing relevant feature description.

Therefore, it has become one of the prominent tasks for the industries to provide a method for feature description and a feature descriptor using the same capable of expediting feature comparison and reducing the required data volume for feature description.

### SUMMARY

The disclosure is directed to a method for feature description and a feature descriptor using the same capable of generating a binary string to descript a feature patch obtained by a feature extraction algorithm. The generated binary string may be used to expedite feature comparison to a real-time manner. Moreover, since the binary string only requires a small amount of data volume, the required memory space may be greatly reduced.

According to one embodiment, a method for feature description is provided. The method includes steps of: receiving high dimension data corresponding to a feature patch obtained by a feature extraction algorithm; selecting a plurality of dimension data sets from the high dimension data; comparing different dimension data in each dimension data set to generate a corresponding comparing result for each dimension data set; and generating a binary string according to the comparing results to descript the feature patch.

According to another embodiment, a feature descriptor is provided. The feature descriptor includes a receiver, a data selector, a comparator and a string generator. The receiver receives high dimension data corresponding to a feature patch obtained by a feature extraction algorithm. The data selector selects a plurality of dimension data sets from the high dimension data. The comparator compares different dimension data in each dimension data set to generate a corresponding comparing result for each dimension data set. The string generator generates a binary string according to the comparing results to descript the feature patch.

The above and other aspects of the invention will become better understood with regard to the following detailed description of the preferred but non-limiting embodiment (s). The following description is made with reference to the accompanying drawings.

### BRIEF DESCRIPTION OF THE DRAWINGS

FIG. 1 shows a block diagram of a feature descriptor according to an embodiment of the present disclosure.

FIG. 2 shows a method for feature description according to an embodiment of the present disclosure.

FIG. 3 shows a schematic diagram of an example of binarizing a feature patch to generate a corresponding the binary string.

FIG. 4 shows a schematic diagram of performing feature comparison with a binary string.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

A number of embodiments of the present invention are disclosed below with reference to accompanying drawings, but not every embodiment is illustrated in accompanying drawings. In practical application, the present invention may have different variations and is not limited to the embodiments exemplified in the specification. A number of embodiments are disclosed in the present disclosure to meet the statutory requirements. Designations common to the accompanying drawings are used to indicate identical or similar elements.

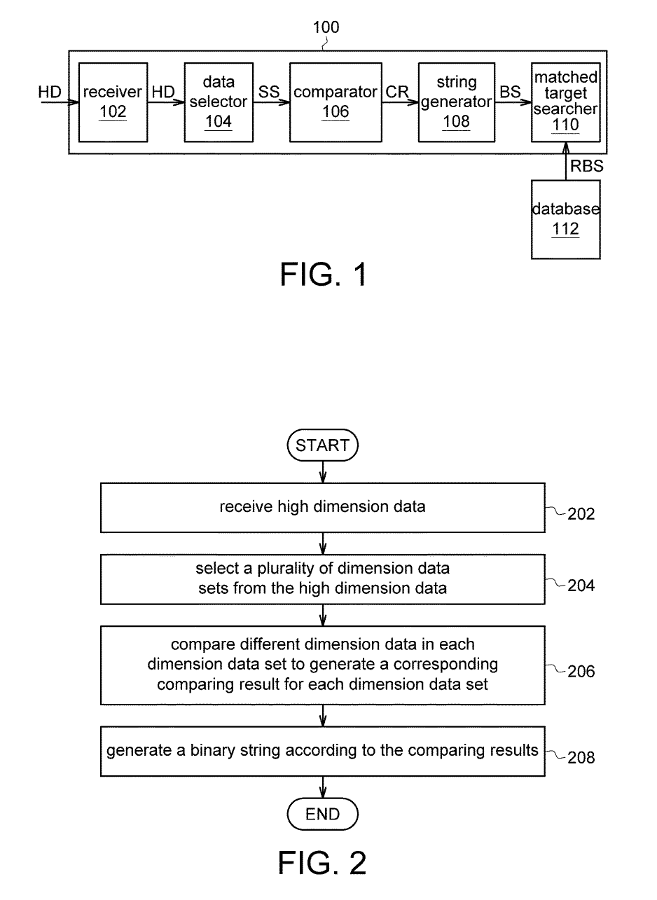

Refer to FIG. 1 and FIG. 2. FIG. 1 shows a block diagram of a feature descriptor 100 according to an embodiment of the present disclosure. FIG. 2 shows a method for feature description according to an embodiment of the present disclosure. The feature descriptor 100 may be realized by such as a micro-processor, a central processing unit, a special purpose processor or other arithmetic processing circuits or realized by a processing unit which reads at least a readable code from at least a memory device.

The feature descriptor 100 mainly includes a receiver 102, a data selector 104, a comparator 106 and a string generator 108. In step 202, high dimension data HD is received by the receiver 102, wherein the high dimension data HD correspond to a feature patch obtained by a feature extraction algorithm. The feature extraction algorithm may be realized by such as a scale-invariant feature transform (SIFT) algorithm or a speeded up robust features (SURF) algorithm.

In step 204, a plurality of dimension data sets SS are selected from the high dimension data HD by the data selector 104, wherein each dimension data set SS includes, for example, at least two dimension data of different dimensions of the high dimension data HD. In an embodiment, the data selector 104 may randomly select dimension data from the high dimension data HD to generate the dimension data sets SS. In an embodiment, the data selector 104 may select dimension data from the high dimension data HD according to a predetermined sequence to generate the dimension data sets SS.

In step 206, different dimension data in each dimension data set SS are compared by the comparator 106 to generate a corresponding comparing result CR in each dimension data set SS.

In step 208, a binary string BS is generated by the string generator 108 according to the comparing results CR, wherein the binary string BS descripts the said feature patch. In short, the feature descriptor 100 of the present disclosure embodiment may binarize the comparing results CR of different dimension data and further use the generated binary string BS to descript a feature patch obtained by a feature extraction algorithm.

In an embodiment as indicated in FIG. 1, the feature descriptor 100 further includes a matched target searcher 110. The matched target searcher 110 may compare the binary string BS with a reference binary string RBS pre-stored in the database 112 to determine whether the feature patch descripted by the binary string BS matches the reference feature patch descripted by the reference binary string RBS. In an embodiment, the matched target searcher 110 may determine whether the feature patch matches the reference feature patch according to a Hamming distance between the binary string BS and the reference binary string RBS. The matched target searcher 110 may perform an XOR operation on the binary string BS and the reference binary string RBS to determine the Hamming distance between the binary string BS and the reference binary string RBS. In general, the smaller the Hamming distance, the higher the similarity between the binary string BS and the reference binary string RBS. When the similarity reaches a certain degree, this indicates that the feature patch matches the reference feature patch. Meanwhile, as long as the content of the reference feature patch is known, the content of the feature patch will be recognized.

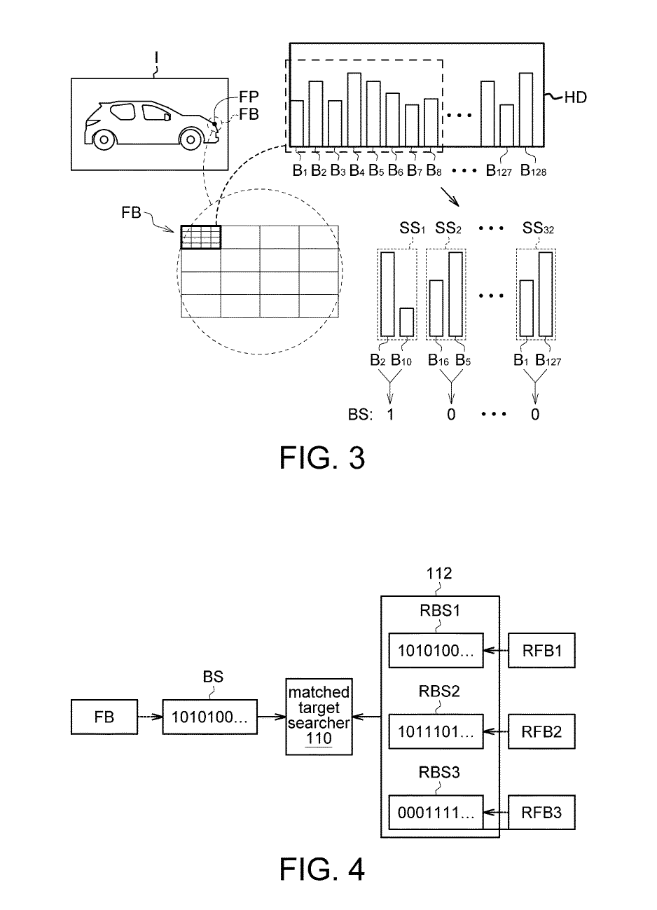

FIG. 3 shows a schematic diagram of an example of binarizing a feature patch FB to generate a corresponding the binary string. In the example of FIG. 3, the feature point FP is extracted from an image I. The feature point FP may be a protruding part of the image I such as a contour, a sharp corner or a spot. The feature point FP may be detected by various feature extraction algorithms.

The feature patch FB may include mxn (such as 16×16) pixels surrounding the feature point FP. In the example of FIG. 3, the feature patch FB is divided into p×q (such as 4×4) sub-blocks. Corresponding high dimension data HD may be generated by collecting the statistics of the pixel data of each sub-block. The high dimension data HD may be represented by a histogram, in which different bars represent dimension data of different dimensions. For instance, 8 corresponding dimension data B1-B8 may be generated by collecting the statistics of the gradients of the pixel data of a sub-block (such as the top left block of the feature patch FB) in 8 directions. Thus, 16 sub-blocks correspond to 16×8 (=128) dimension data B1-B128 as indicated in FIG. 3. However, the present disclosure is not limited thereto, and the dimension data in the high dimension data HD may be defined by other statistical parameters.

In an embodiment, two dimension data with different dimensions may be randomly selected for comparison, and the value of one bit of the binary string BS may be determined according to the comparing results (the bit value is such as “0” or “1”). As indicated in FIG. 3, 32 dimension data sets SS1-SS32 are selected from the high dimension data HD, wherein each of the dimension data set SS1-SS32 includes a first dimension data and a second dimension data. For instance, the dimension data set SS1 includes randomly selected first dimension data B2 and second dimension data B10; the dimension data set SS2 includes randomly selected first dimension data B16 and second dimension data B5; and the dimension data set SS32 includes randomly selected first dimension data B1 and second dimension data B127.

In an embodiment, the comparator 106 may compare the first dimension data with the second dimension data to determine the value of one bit of the binary string BS. For instance, when the first dimension data is larger than the second dimension data, a first value (such as “1”) is outputted; when the first dimension data is smaller than the second dimension data, a second value (such as “0”) is outputted. As indicated in FIG. 3, when the first dimension data B2 of the dimension data set SS1 is larger than the second dimension data B10, the value of the first bit of the binary string BS is “1”. Similarly, when the first dimension data B16 of the dimension data set SS2 is smaller than the second dimension data B5, the value of the second bit of the binary string BS is “0”, and the values of remaining bits may be obtained in the same manner.

Through the said mechanism, the high dimension data HD which originally include 128 dimension data B1-B128 may be simplified as a 32-bit binary string BS. Thus, the feature patch FB originally descripted by the high dimension data HD is simplified to be descripted by the 32-bit binary string BS, which not only expedites the comparison speed but also reduces the data volume required for feature description.

In some embodiments, the dimension data may be selected for comparison according to a predetermined sequence/rule to determine the bit values of the binary string BS. For instance, the comparator 106 may compare each dimension data with its closest dimension data to determine the value of at least one bit of the binary string BS. For example, each of the dimension data sets SS may include a first dimension data and a second dimension data, wherein the first dimension data is the dimension data of the dimension data set SS closest to the second dimension data. Take the dimension data B1, B2, B5 shown in FIG. 3 as an example, the dimension data B2 is closer to dimension data B1, and the dimension data B5 is farther away from the dimension data B1. Meanwhile, the comparator 106 may compare the first dimension data with the second dimension data to determine the value of one bit of the binary string BS. The comparator 106 may further compare the last item of dimension data of the dimension data set SS with the first item of dimension data to determine the value of one bit of the binary string BS and thus form a cycle calculation.

Alternatively, the comparator 106 may compare each dimension data with an average of its K (such as 5) previous dimension data to determine the value of one bit of the binary string BS. For instance, given that N dimension data are selected to form the dimension data set SS to determine the value of one bit of the binary string BS, the comparator 106 may compare the N-th dimension data of the N dimension data with the average of K dimension data previous to the N-th dimension data to determine the value of one bit of the binary string BS, wherein both N and K are a positive integer, and K is smaller than N.

FIG. 4 shows a schematic diagram of performing feature comparison with a binary string BS. As indicated in FIG. 4, the database 112 pre-stores reference binary strings RBS1, RBS2 and RBS3 corresponding to reference feature patches RFB1, RFB2 and RFB3. The reference feature patches RFB1, RFB2 and RFB3 are, for example, known feature patterns, such as signs or other feature snaps. The reference binary strings RBS1, RBS2 and RBS3 are binary strings generated from the reference feature patches RFB1, RFB2 and RFB3 through the abovementioned binarization of feature description mechanism for example. In FIG. 4, the matched target searcher 110 may compare the binary string BS with each of the reference binary strings RBS1, RBS2 and RBS3 corresponding to the reference feature patches RFB1, RFB2 and RFB3, respectively. For example, the matched target searcher 110 may calculate the Hamming distance to determine the reference feature patch to which the corresponding feature patch FB of the binary string BS corresponds. Given that the Hamming distance between the binary string BS and reference binary string RBS1 is the smallest, it may be determined that the binary string BS matches the reference binary string RBS1, which implies that the content of the feature patch FB corresponds to the reference feature patch RBS1.

As disclosed above, the method for feature description and the feature descriptor using the same may generate a binary string to descript a feature patch obtained by a feature extraction algorithm. The generated binary string may be used to expedite feature comparison. Furthermore, since the binary string only requires a small amount of data volume, the required memory space may be greatly reduced.

It will be apparent to those skilled in the art that various modifications and variations may be made to the disclosed embodiments. It is intended that the specification and examples be considered as exemplary only, with a true scope of the disclosure being indicated by the following claims and their equivalents.

What is claimed is:

1. A method for feature description, comprising:
receiving high dimension data corresponding to a feature patch obtained by a feature extraction algorithm;
selecting a plurality of dimension data sets from the high dimension data;
comparing different dimension data in each dimension data set to generate a corresponding comparing result for each dimension data set; and
generating a binary string according to the comparing results to descript the feature patch.

2. The method for feature description according to claim 1, wherein one of the dimension data sets comprises a first dimension data and a second dimension data, and the method for feature description further comprises:
comparing the first dimension data with the second dimension data to determine a value of one bit of the binary string.

3. The method for feature description according to claim 2, wherein the first dimension data is the dimension data closest to the second dimension data among the dimension data sets.

4. The method for feature description according to claim 2, wherein the first dimension data is the first item of dimension data of the dimension data sets, and the second dimension data is the second item of dimension data of the dimension data sets.

5. The method for feature description according to claim 1, wherein the dimension data sets comprises N dimension data, and the method for feature description further comprises:
comparing the N-th dimension data of the N dimension data with an average of K dimension data previous to the N-th dimension data to determine a value of one bit of the binary string, wherein both N and K are a positive integer, and K is smaller than N.

6. The method for feature description according to claim 1, further comprising:
randomly selecting the dimension data from the high dimension data to generate the dimension data sets.

7. The method for feature description according to claim 1, further comprising:
selecting the dimension data from the high dimension data according to a predetermined sequence to generate the dimension data sets.

8. The method for feature description according to claim 1, further comprising:
comparing the binary string with a reference binary string to determine whether the feature patch descripted by the binary string matches a reference feature patch descripted by the reference binary string.

9. The method for feature description according to claim 8, further comprising:
determining whether the feature patch matches the reference feature patch according to a Hamming distance between the binary string and the reference binary string.

10. The method for feature description according to claim 8, further comprising:
performing an XOR operation on the binary string and the reference binary string to obtain a Hamming distance between the binary string and the reference binary string.

11. A feature descriptor, comprising:
a receiver for receiving high dimension data corresponding to a feature patch obtained by a feature extraction algorithm;
a data selector for selecting a plurality of dimension data sets from the high dimension data;
a comparator for comparing different dimension data in each dimension data set to generate a corresponding comparing result for each dimension data set; and
a string generator for generating a binary string according to the comparing results to descript the feature patch.

12. The feature descriptor according to claim 11, wherein one of the dimension data sets comprises a first dimension data and a second dimension data, and the comparator compares the first dimension data with the second dimension data to determine a value of one bit of the binary string.

13. The feature descriptor according to claim 12, wherein the first dimension data is the dimension data closest to the second dimension data among the dimension data sets.

14. The feature descriptor according to claim 12, wherein the first dimension data is the first item of dimension data of the dimension data sets, and the second dimension data is the second item of dimension data of the dimension data sets.

15. The feature descriptor according to claim 11, wherein the dimension data sets comprises N dimension data, and the comparator compares the N-th dimension data of the N dimension data with an average of K dimension data previous to the N-th dimension data to determine a value of one bit of the binary string, wherein both N and K are a positive integer, and K is smaller than N.

16. The feature descriptor according to claim 11, wherein the data selector randomly selects the dimension data from the high dimension data to generate the dimension data sets.

17. The feature descriptor according to claim 11, wherein the data selector selects the dimension data from the high dimension data according to a predetermined sequence to generate the dimension data sets.

18. The feature descriptor according to claim 11, further comprising:
a matched target searcher for comparing the binary string with a reference binary string to determine whether the feature patch descripted by the binary string matches a reference feature patch descripted by the reference binary string.

19. The feature descriptor according to claim 18, wherein the matched target searcher determines whether the feature patch matches the reference feature patch according to a Hamming distance between the binary string and the reference binary string.

20. The feature descriptor according to claim 18, wherein the matched target searcher performs an XOR operation on the binary string and the reference binary string to obtain a Hamming distance between the binary string and the reference binary string.
